(19) United States
(12) Patent Application Publication
(10) Pub. No.: US 2014/0084125 A1
(43) Pub. Date: Mar. 27, 2014

(54) GUARD FOR SURFACE MOUNTED TETHER DEVICE

(71) Applicants: Timothy D. Crawford, Golden, CO (US); Martin L. Brooks, Las Vegas, NV (US)

(72) Inventors: Timothy D. Crawford, Golden, CO (US); Martin L. Brooks, Las Vegas, NV (US)

(21) Appl. No.: 13/628,375

(22) Filed: Sep. 27, 2012

(51) Int. Cl. F16P 1/00; F16M 13/02

(52) U.S. Cl. CPC F16P 1/00; F16M 13/02
USPC 248/499; 16/109

(57) ABSTRACT

Tether guards are disclosed herein. An embodiment of a tether guard includes a plate configured to contact a surface. The plate has a hole extending therethrough, wherein the hole is adapted to receive a securing mechanism that secures a tether to the surface. The tether guard also includes a cover that is attachable to the plate, the cover has an opening wherein the tether is passable through the opening.

This application claims priority to U.S. provisional patent application 61/540,959 for GUARD FOR SURFACE MOUNTED TETHER DEVICE, filed on Sep. 29, 2011, which is hereby incorporated by reference for all that is disclosed therein.

### BACKGROUND

Many structures and other devices are retained in place by the use of tethers. The tethers are commonly attached to a surface, such as a floor. An eye bolt or other securing mechanism is used to connect the tether floor, wherein the securing mechanism typically extends from the surface. The securing mechanism can be dangerous by causing people to trip over the securing mechanism. The problem is exasperated when the structure is used by kids, so there a lot of kids in the proximity of the securing mechanism. In the case of inflatable bounce-type devices, the kids may be running and not paying attention to the securing mechanism.

### BRIEF DESCRIPTION OF THE DRAWINGS

FIG. 1 is a front, elevation view of an embodiment of a tether guard.

FIG. 2 is a top plan view of the tether guard of FIG. 1.

FIG. 3 is a top plan view of an embodiment of the plate of FIG. 1.

FIG. 4 is a side elevation view of the tether guard of FIG. 4 used in conjunction with an inflatable.

### DETAILED DESCRIPTION

Devices are disclosed herein that reduce the possibility that a person trips over a securing mechanism attached to a surface, such as a floor. Securing mechanisms are typically secured to a floor or other surface and are used to secure items to the floor or surface. The securing mechanisms usually extend from the surface. A tether may be connected to the securing mechanism, which in turn is typically connected to the item being secured to the surface. In many embodiments, the structure is a play area, such as an inflatable structure or bounce-type inflatable devices for kids. Because kids are in the vicinity of the structures, there is a probability that they can trip over the securing mechanism. Tether guards are disclosed herein that reduce the likelihood of tripping on the securing mechanisms while not interfering with the tether.

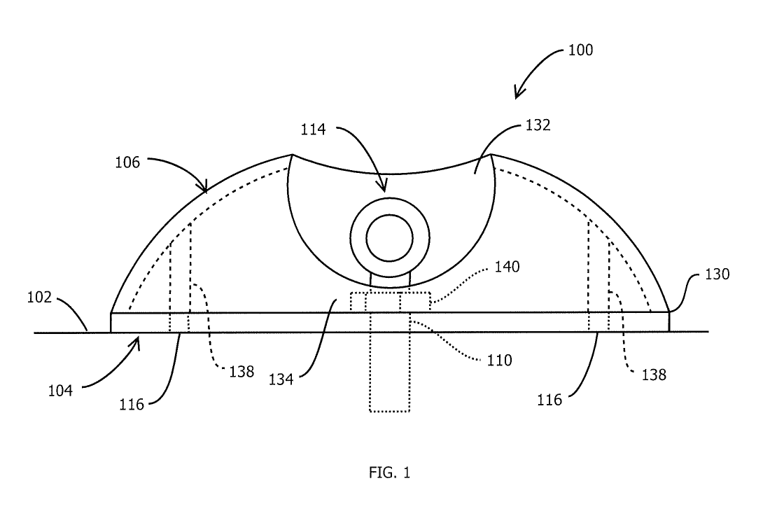

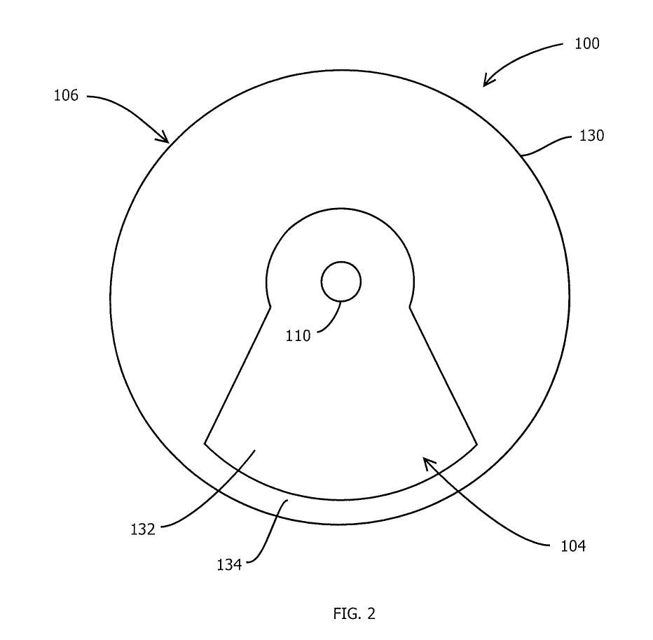

A front, elevation view of an embodiment of a tether guard 100 is shown in FIG. 1. The embodiment of FIG. 1 shows the tether guard 100 mounted to a surface 102. FIG. 2 is a top plan view of the tether guard 100 of FIG. 1, but not mounted to a surface. The surface 102 may be a floor or ground. The item described above is attached to the surface 102 as described in greater detail below.

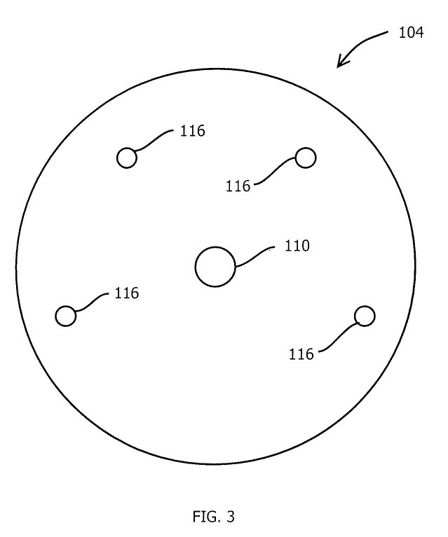

The tether guard 100 is described as being in two pieces, a plate 104 and a cover 106. A top plan view of the plate 104 is shown in FIG. 3. The plate 104 may be made of a substantially rigid material, such as metal or hard plastic. The plate 104 has a first hole 110 through which a securing mechanism 114, FIG. 1, passes. In some embodiments, the hole 110 is surrounded by a rigid component (not shown), such as a washer or spacer that prevents the securing mechanism 114 from contacting the remaining portion of the plate 104. As described in greater detail below, the plate 104 is located between the securing mechanism 114 and the surface 102 and may come under a large compressive force when the plate 104 is secured to the surface 102. The rigid component serves to prevent the plate 104 from cracking or otherwise breaking when under the force.

The plate 104 may also have a plurality of second holes 116 that serve to attach the cover 106 to the plate 104. The cover 106 may have a plurality of bosses on the interior that extend toward the location of the second holes 116. Screws or other fasteners pass through the second holes 116 and into the bosses. Accordingly, the screws secure the cover 106 to the plate 104.

The cover 106 is depicted in FIGS. 1 and 2 as being semispherical or dome-shaped. The dome shape is larger than the securing mechanism 114 and improves the ability for the tether guard 100 to be seen and avoided. In addition, the shape of the cover 106 lessens the likelihood that a person will trip on the securing mechanism 114. More specifically, if the person contacts the cover 106, he will be less likely to trip than if he were to contact the securing mechanism 114 directly. It is noted that the cover 106 may have many other shapes. For example, the cover 106 may be ornamental. Examples of ornamental covers 114 include the shapes of insects, such as ladybugs that are dome-shaped. In other embodiments, the cover 106 is in the shape of an animal, such as a turtle or a rabbit. As stated above, the cover 106 is fastened to the plate 104, so different covers 106 may be attached to the same type of plate 104.

The embodiment of the cover 106 in FIG. 1 has a perimeter 130 proximate the plate 104. The perimeter 130 is substantially the same as the perimeter of the plate 104. When the cover 106 has a more ornamental shape, the perimeter 130 may be larger or smaller than the perimeter of the plate. For example, if the cover 106 is in the shape of a ladybug, the perimeter 130 may include features that make it larger than the perimeter of the plate 104.

The cover 106 has an opening 132 that enables access to the securing mechanism 114 and enables the above described tether to pass from the securing mechanism 114 to another location. In the embodiment of FIGS. 1 and 2, the opening 132 is bounded by a connecting portion 134 proximate the first perimeter 130 that provides structural integrity for the cover 106. In some embodiments, the opening 132 extends to the first perimeter 130 so as to break the first perimeter 130. The edges of the opening 132 may be curved toward the interior of the dome 130 in order to prevent a person from getting caught on the edges of the opening 132.

The interior of the dome 104 also has a plurality of bosses 138 that align with the second holes 116 in the plate 104. The bosses 138 have holes to receive screws that pass through the second holes 116. The screws in conjunction with the bosses 138 serve to secure the cover 106 to the plate 104. It is noted that other mechanisms may be used to attach the cover 106 to the plate 104 and in some embodiments, the plate 104 and cover 106 are a single component.

Having described the components of the tether guard, its operation will now be described.

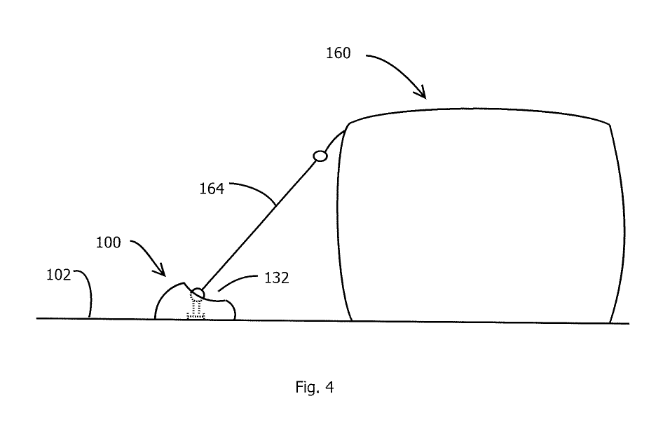

Additional reference is made to FIG. 4, which is a side view of the tether guard 100 used to secure an inflatable device to the surface 102 by way of a tether 162. The inflatable 160 may be an inflatable device that kids bounce on. The surface 102 has a hole or other mechanism that receives the securing mechanism 114. In the embodiment of FIG. 1, the securing mechanism 114 is an eye bolt that screws into the surface 102. Accordingly, the surface 102 has a threaded hole that receives the eye bolt. A nut 140 is threaded onto the securing mechanism far enough so as not to interfere with the securing mechanism being threaded into the hole in the surface 102. The tether guard 100 is placed over the threaded hole so that the hole 110 in the plate 104 is located over the threaded hole in the surface 102. The securing mechanism 114 is then placed through the hole 110 and screwed into the threaded hole in the surface 102. The securing mechanism 114 is placed in the hole far enough and tight enough to secure the tether 162.

At this point, the securing mechanism 114 is threaded into the surface 102 and extends through the plate 104. The tether guard 100 is rotated so that the opening 130 faces the direction in which the tether 162 extends. The nut 140 is then rotated so that it contacts the plate 104. The nut 140 serves to secure the plate 104 and, thus, the tether guard 100 to the surface 102. In many embodiments, the nut 140 is not required. In some embodiments, the securing mechanism 114 may have a washer or other retaining device located thereon that contacts the plate 104 when the securing mechanism 114 is secured to the surface 102. The washer distributes the force exerted by the nut 140 so as not to break the plate 104. It is noted that access to the securing mechanism 114 and the nut 140 is obtained via the opening 130.

The tether 162 is attached to the securing mechanism 114. Thus, the inflatable 160 is secured to the surface 102 by way of the securing mechanism 114 and the tether 162. The tether cover 100 is positioned above the securing mechanism 114, which prevents people from tripping over the securing mechanism 114.

Having described some embodiments of the tether guard 100 and its use, other embodiments will now be described.

In one embodiment, the hole 110 in the plate 104 is a slot extending to the exterior of the tether guard 100. This configuration may be used in situations where the securing mechanism 114 is not readily removable from the surface 102. The slot enables the tether guard to be slid onto the securing mechanism 114 and secured thereto.

Additional holes (not shown) may be placed through the plate 104. Screws or other securing devices may be placed through the holes and into the surface to provide additional attachments to the surface 102. Such embodiments may be used when the cover 106 is large or oblong or where the tether guard 100 is subjected to forces that may exceed the strength of the securing mechanism 114.

While illustrative and presently preferred embodiments of the invention have been described in detail herein, it is to be understood that the inventive concepts may be otherwise variously embodied and employed and that the appended claims are intended to be construed to include such variations except insofar as limited by the prior art.

What is claimed is:

1. A tether guard comprising:
a plate configured to contact a surface, the plate having a first hole extending therethrough, wherein the first hole is adapted to receive a securing mechanism, the securing mechanism being attachable to the surface and the tether; and
a cover that is attachable to the plate, the cover having an opening wherein the tether is passable through the opening.

2. The tether guard of claim 1, wherein a void is located between the plate and the cover and wherein at least a portion of the securing mechanism is locatable in the void.

3. The tether guard of claim 2, wherein the securing mechanism has an eye hook and wherein the eye hook is receivable in the void.

4. The tether guard of claim 1, wherein the plate has a perimeter and wherein at least a portion of the cover is located adjacent the perimeter.

5. The tether guard of claim 1, wherein the plate has a perimeter and wherein the cover extends to the plate.

6. The tether guard of claim 1, wherein the opening in the cover has a portion that is located opposite the hole in the plate.

7. The tether guard of claim 1, wherein the opening in the cover has a portion that is located opposite the hole in the plate and extends at least partially to the perimeter of the cover.

8. The tether guard of claim 1, wherein the cover is dome-shaped.

9. The tether guard of claim 1, wherein the plate has at least one second hole, wherein a fastener is receivable in the at least one second hole, and wherein the fastener serves to secure the plate to the surface.

10. The tether guard of claim 1 and further comprising a securing mechanism extending through the first hole.

11. The tether guard of claim 10, wherein the securing mechanism has a hook and wherein the hook is located between the plate and the cover.

12. The tether guard of claim 10, wherein the plate is on a surface and wherein the securing mechanism is secured to the surface.

13. The tether guard of claim 10 and further comprising a tether having a first end and a second end, wherein the first end is attached to the securing mechanism, the tether extending through the hole in the cover, wherein the second end is located outside of the cover.

14. The tether guard of claim 13, wherein the second end of the tether is attached to an inflatable device.

15. An inflatable device comprising:
a tether extending from the inflatable device;
a tether guard attached to the tether, the tether guard comprising:
a plate configured to contact a surface, the plate having a hole extending therethrough
a securing mechanism extending through the hole in the plate and attached to the surface, wherein the tether is attached to the securing mechanism; and
a cover attached to the plate, the cover having an opening wherein the tether passes through the opening.

16. The inflatable device of claim 15, wherein the tether is attached to the securing mechanism at a point, and wherein the point is between the plate and the cover.

17. The inflatable device of claim 15, wherein the portion of the securing mechanism passing through the plate is attached to the surface and wherein a portion of the securing mechanism located between the plate and the cover is threaded and further comprising a nut threaded onto the securing mechanism, wherein the nut is threaded against the plate to secure the plate to the surface.

18. The inflatable device of claim 15, wherein the hole in the cover corresponds with the direction in which the tether extends.

19. The inflatable device of claim 18, wherein the securing mechanism has an eye hook and wherein the tether is attached to the eye hook.

20. A tether guard comprising:
a plate configured to contact a surface, the plate having a hole extending therethrough, wherein the hole is adapted to receive a securing mechanism, the securing mechanism being attachable to the surface and the tether; and
a dome-shaped cover that is attachable to the plate, the cover having an opening wherein the tether is passable through the opening and wherein the opening in the cover has a portion that is located opposite the hole in the plate;
wherein a void is located between the plate and the cover and wherein at least a portion of the securing mechanism is locatable in the void.
